(19) United States
(12) Patent Application Publication
(10) Pub. No.: US 2005/0044432 A1
(43) Pub. Date: Feb. 24, 2005

(54) Method of controlling network system

(75) Inventor: Jung-il Park, Seoul City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/919,364

(22) Filed: Aug. 17, 2004

(30) Foreign Application Priority Data
Aug. 18, 2003 (KR) 2003-56889

(51) Int. Cl. G06F 11/30

(52) U.S. Cl. 713/300

(57) ABSTRACT

Monitoring a connection with a network system by informing a monitoring computer working with another computer on the network of a predictable network disconnection event. For example, when employing a battery as a power source to the other computer, a remaining battery power of the battery is detected and power information based on the detected remaining battery power is transmitted to the monitoring computer. The monitoring computer indicates the received power information, thereby allowing the monitoring computer to prepare against such sudden predictable network disconnection.

### CROSS-REFERENCE TO RELATED APPLICATIONS

This application claims the priority benefit of Korean Patent Application No. 2003-56889, filed Aug. 18, 2003, in the Korean Intellectual Property Office, the disclosure of which is incorporated herein by reference.

### BACKGROUND OF THE INVENTION

1. Field of the Invention

The present invention relates to a method of controlling a network system, and more particularly, to a method of controlling a network system, in which a computer using a battery notifies remaining battery power to a monitoring computer connected therewith over a network, so that the monitoring computer can prepare against sudden disconnection.

2. Description of the Related Art

As computer and communication technology is developed, data network related work, such as mutual working, file transmission, etc., performed on the computer data network system becomes commonplace. Here, as an example, the computer network system is generally called the Internet, for example, World Wide Web. Typically, the computer network system comprises computers including a portable computer as well as a desktop computer.

While working on the computer network system, each computer checks a network connection by an ACK (acknowledgment) signal from a remote computer. When the computer is suddenly disconnected from the network while working on the computer network system, the computer receives no ACK signal from a remote computer and aborts the working, which can confuse a user. Further, data being processed may be damaged, and therefore a user has to work all over again after the network connection resumes. To prepare against a sudden disconnection, there is a need to secure a predetermined time with regard to at least predictable network disconnection events, for example, a disconnection event due to exhaustion of battery power in the portable computer connected to the network.

### SUMMARY OF THE INVENTION

Accordingly, the present invention provides a method of controlling a connection to a network system, in which a computer notifies a monitoring computer connected therewith over a network of a predictable network disconnection event, thereby allowing the monitoring computer to prepare for a sudden disconnection because of the predictable network disconnection event. For example, the present invention provides a method of monitoring a connection to a network system, in which a computer using a battery notifies remaining battery power to a monitoring computer connected therewith over a network, so that the monitoring computer can prepare against a sudden disconnection because of the battery operated computer power issues.

Additional aspects and/or advantages of the invention will be set forth in part in the description which follows and, in part, will be obvious from the description, or may be learned by practice of the invention.

The present invention may be achieved by providing a method of controlling a network system in which a monitoring computer works with a computer employing a battery as a power source over a network, the method comprising detecting remaining battery power of the battery; transmitting power information based on the remaining battery power to the monitoring computer; and indicating (notifying of) the power information in the monitoring computer.

According to an aspect of the invention, the power information is determined by converting the remaining battery power into an allowable operating time.

According to an aspect of the invention, the method further comprises comparing the remaining battery power with a reference remaining power after detecting the remaining battery power, wherein the power information to be indicated is related to a lack of the battery power based upon the comparing.

According to an aspect of the invention, the power information is transmitted to an identified IP address after identifying an IP address of the monitoring computer.

According to an aspect of the invention, the power information is transmitted through a messenger service provided in operation systems of both the computer using the battery and the monitoring computer.

According to an aspect of the invention, the power information is transmitted through an application program executed in both the computer using the battery and the monitoring computer.

According to an aspect of the invention, the power information is transmitted to an external device connected to the computer using the battery through a USB port or an IEEE 1394 port.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a block diagram of a computing device network system used in the present invention;

FIG. 2 is a flowchart of monitoring remaining battery power of a battery-powered computer by a monitoring computer in a process of controlling the computing device network system, according to an embodiment of the present invention;

FIG. 3 is a flowchart of monitoring the remaining battery power of the battery-powered computer by an external device in the process of controlling the computing device network system, according to an embodiment of the present invention; and

FIG. 4 is a screen display image displayed by the monitoring computer of FIG. 2 to display the remaining battery power, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

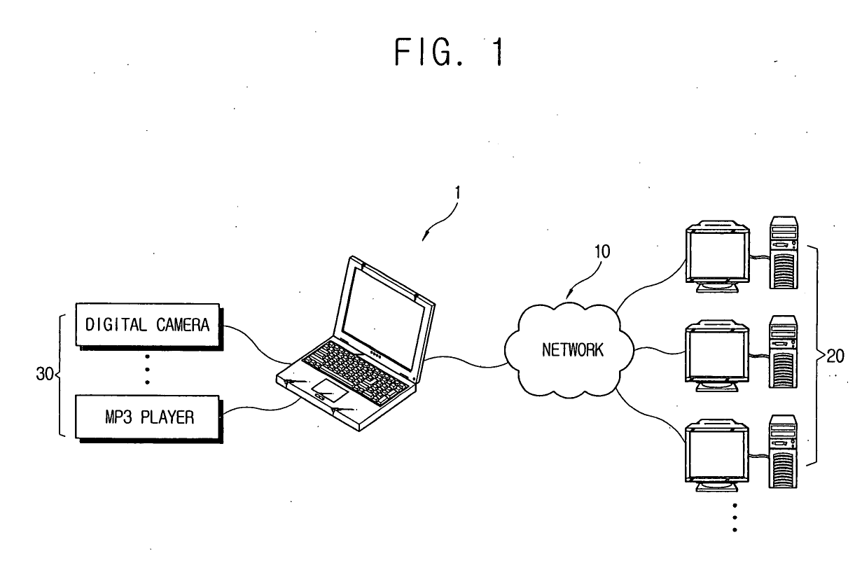

FIG. 1 is a block diagram of a computing device network system used in the present invention. As shown therein, for example, a network system comprises a battery-powered computer 1 using a battery, a monitoring computer 20 displaying remaining battery power of the battery-powered computer 1, and a network 10 over which the battery-powered computer 1 and the monitoring computer 20 are connected. Further, the network system may comprise an external device 30 directly connected to the battery-powered computer 1 through a cable or the like.

According to an aspect of the invention, the battery-powered computer 1 is a portable computer designed to generally use power supplied from the battery, but is not limited thereto, and any computer including a desktop computer, which can use power supplied from the battery, can be employed as the battery-powered computer 1.

The battery-powered computer 1 includes a remaining power detector to detect the remaining battery power of the battery mounted in the battery-powered computer 1, and a power information transmitter to transmit power information about the detected remaining battery power, and further includes a power information converter to convert the detected remaining battery power into the power information, such as an allowable operating time, and a remaining power comparator to compare the detected remaining battery power with a reference remaining power.

Here, ‘computer’ collectively means a device that comprises a microprocessor having a program to get a predetermined result and processes information of digital data. For example, the device 1 includes not only a PDA (Personal Digital Assistant), an IMT-2000 (International Mobile Telecommunication-2000) device, a mobile telecommunication terminal, a portable computer, a workstation, and other computers larger or smaller than these, but also a digital camera, an MP3 (Moving Picture Experts Group-1 audio layer-3) player, and the like. Typically, the network 10 uses an Internet protocol (IP) allowing a client computer to communicate with a server computer. Here, the network 10 is exemplarily called the Internet, but is not limited thereto, and may include an intranet, an extranet, a private network, etc. The monitoring computer 20, 30 can be any computing device, and includes the PDA, the IMT-2000 device, the mobile telecommunication terminal, the portable computer, the workstation, a client computing device, other computers larger or smaller than these, and any computer which can be connected to the battery-powered computer 1 over the network 10.

According to an aspect of the invention, the external device 30 is a peripheral unit which can be directly connected to the battery-powered computer 1 through a USB (Universal Serial Bus) port, an IEEE 1394 (Institute of Electrical and Electronic Engineers 1394) port, etc. provided in the battery-powered computer 1. Here, the USB port is a kind of a serial port, and provides a PNP (Plug and play) interface between the computer and the peripheral units, such as an audio player, a joystick, a keyboard, a telephone, a scanner, a printer, etc. Further, the IEEE 1394 provides the PNP interface between the computer and the peripheral units 30, such as a digital camcorder, the digital camera, etc.

In this embodiment example, the reference numeral 20 indicates general computers as the monitoring computers to be connected to the battery-powered computer 1 over the network 10, and the reference numeral 30 indicates an external device, such as the digital camera or the MP3 player, directly connected to the battery-powered computer 1 through a predetermined cable (interface) or the like. That is, both the monitoring computer 20 and the external devices 30 can be deemed a monitoring computer. Both the monitoring computer 20 and the external device 30 comprise a power information receiver to receive the power information about the remaining battery power of the battery-powered computer 1, and a power information displaying part to display the received power information.

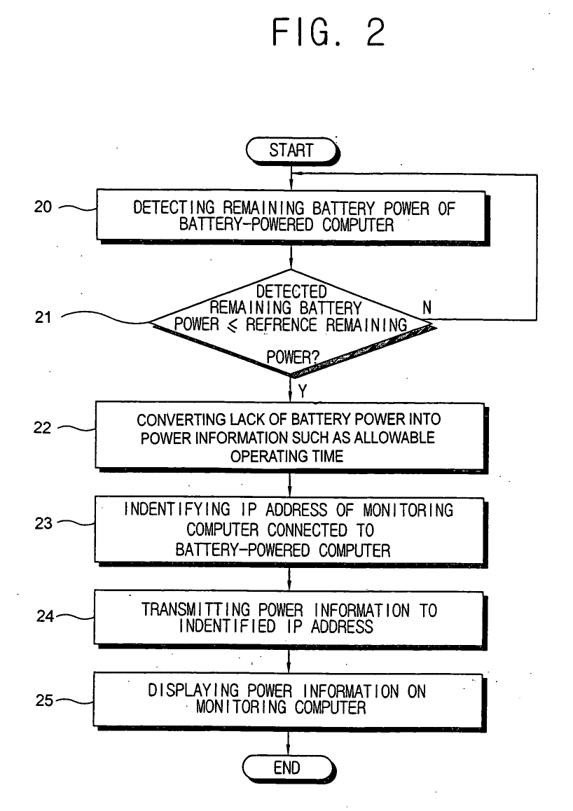

FIG. 2 is a flowchart of monitoring remaining battery power of a battery-powered computer by a monitoring computer in a process of controlling the computing device network system, according to an embodiment of the present invention. As an example, in the foregoing network system of FIG. 1, a method of allowing the monitoring computers 20, 30 (as the case may be) to monitor the remaining battery power of the battery-powered computer 1 will be described hereinbelow with reference to FIG. 2. Here, it is supposed that both the battery-powered computer 1 and the monitoring computer 20 already load respective operating systems and are in a normal state to process predetermined workings (applications). Particularly, according to an aspect of the invention, the battery-powered computer 1 and the monitoring computer 20 are connected over the network 10, so that an operation, such as file transmission, from the battery-powered computer 1 to the monitoring computer 20 is being performed or possible.

First, at operation 20, the battery-powered computer 1 detects the remaining battery power thereof, according a predetermined timing according to a desired application. At operation 20, any method generally used for detecting the remaining battery power of a computer system capable of employing the battery as a power source is possible. For example, there are various methods of detecting the remaining battery power by measuring voltage, current and/or temperature of the battery and then determining the remaining battery power as the remaining battery power corresponding to the measured voltage, the measured current and/or the measured temperature previously stored in a remaining battery power table; by converting an elapsed time after charging the battery into the remaining battery power; etc.

According to an aspect of the invention, the detected remaining battery power is periodically stored in a memory provided in the microprocessor of the battery-powered computer 1, and then read from the memory. Then, at operation 21, the detected remaining battery power is compared with a comparison reference. Typically, the comparison reference is a reference remaining power to determine a lack of battery power. Typically, the reference remaining power is defined as a degree of remaining battery power with respect to when processing of a work (a processing operation) may be aborted abnormally because of a lack of power (i.e., abnormal operation abortion because of any power supply issue that can be predicted, such as when the battery is exhausted, fails, too low, etc.), and therefore when the lack of battery power needs to be notified to the monitoring computer 20, 30 (as the case may be). For example, the reference remaining power can be set up as necessary within a range from 5% to 95% of a full charged state (from an almost discharged state to an almost charge state), but, typically, the reference remaining power is set to be less than 50%.

The foregoing operation 21 is just needed in a system configuration to warn of the lack of the battery power, and operation 21 can be omitted in a system configuration when just the remaining battery power of the battery-powered computer 1 is reported to (monitored by) the monitoring computer 20.

As a result of the comparison, at operation 21, when the detected remaining battery power is higher than the reference remaining power, there is no need to warn of the lack of the battery power, so that operation 20 at which time the detection of the remaining battery power is repeated. Oppositely, at operation 21, when the detected remaining battery power is lower than the reference remaining power or when the operation 21 is omitted, typically, at operation 22, the detected remaining battery power or the lack of battery power (as the case may be) is converted into power information, such as an allowable operating time. According to an aspect of the invention, at operation 21, the lack of battery power is determined and used as the power information. On the other hand, according to another aspect of the invention, the remaining battery power or the lack of batter power (as the case may be) is converted into new power information, which can be advantageous because in a stand-alone computer using the battery as well as the network system, representing the remaining battery power as a percentage of a full charged state or by the general three techniques discussed above might not be adequate to protect the data or the computer system from a sudden abort due to a complete discharge of the battery. In other words, the remaining battery power or the lack of battery power by itself may not be adequate, because, typically, a user may not be able to determine how much computing time remains, depending on the processing mode or operation(s) being performed (or desired to be performed) and the remaining battery power, to avoid a sudden computer system abort due to the battery failure. Therefore, according to an aspect of the invention, typically, the remaining battery power is represented as the allowable operating time which lets a user to directly know a time during which the battery can be continuously used to perform computing related operations.

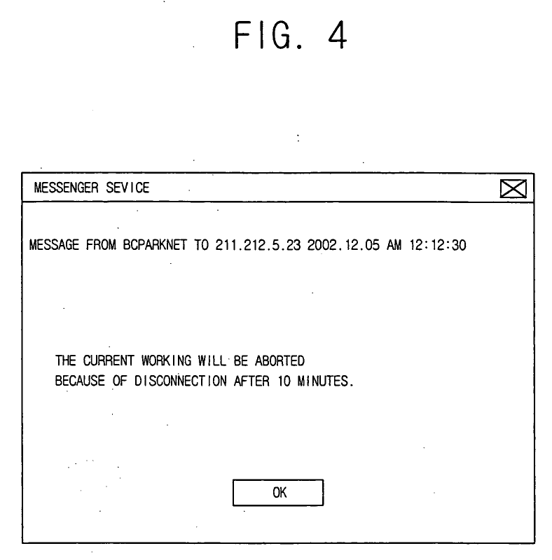

According to an aspect of the invention, when the detected remaining battery power is converted into the allowable operating time, factors affecting power consumption of the battery-powered computer 1 can be considered, for example, the kind of mutual working (data communication) being currently processed in the network 10, a current power mode of the battery-powered computer 1, the number and/or the kind of application programs being currently executed in the battery-powered computer 1, and so on. Therefore, the power information is a message including, for example, the converted allowable operating time to be displayed on the monitoring computers 20, 30, as shown in FIG. 4. According to an aspect of the invention, typically, the power information message includes not only, in this example, the allowable operating time, but also the remaining battery power or the lack of the battery power (as the case may be), a countermeasure to the remaining or lack of the battery power, etc.

After operation 22, when the power information to be displayed on the monitoring computers 20, 30 (as the case may be) is determined, at operation 23, typically, the battery-powered computer 1 identifies an IP address of the monitoring computers 20, 30 (as the case may be) connected to the battery-powered computer 1 as destination network disconnect event monitors. In this example embodiment, operation 23 is performed after operation 22, but the present invention is not limited thereto, and operations 22 and 23 can be performed reversibly or simultaneously because they can be independently performed.

The Internet employs TCP/IP (Transmission Control Protocol/Internet Protocol) as the basic communication protocol. The TCP/IP is a two-layer program. The higher layer, the TCP, manages assembling of a message or a file into smaller packets that are transmitted over the Internet and receiving by a TCP layer that reassembles the packets into the original message. The lower layer, the IP, handles the address part of each packet, so that the message gets to a correct or desired destination. Typically, gateway devices on the network 10 check this IP address to see where to forward the message. At operation 23, a method of identifying the IP address of a remote computer connected to the battery-powered computer 1 over the network 10 can employ the conventional methods.

Thereafter, at operation 24, the converted power information is sent to the identified IP address. According to an aspect of the invention, the converted power information message can be transmitted by a messenger service provided in an operating system, for example, the MICROSOFT WINDOWS operation system, as shown in FIG. 4. FIG. 4 is a screen display image displayed by the monitoring computer of FIG. 2 to display the remaining battery power, according to an embodiment of the present invention. Typically, for example, as shown in FIG. 4, at operation 24, to send a message by the WINDOWS operating system messenger service, “Run . . . ” is selected from a start menu of the WINDOWS operating system, and then a program is launched, for example, by inputting the following program as a statement in an input box: “net send 211.212.5.23 ‘the current working will be aborted because of disconnection after 10 minutes’”.

According to another aspect of the invention, at operation 24, a program code can be employed to transmit the power information message to the computer monitors 20, 30. Further, according to another aspect of the invention, an application program, such as WINPOPUP in the WINDOWS operating system can be employed. In this case, it is supposed that the monitoring computer 20 receiving the converted power information message also has the same application program and the application program is being executed while the monitoring computer 20 receives the power information message. Further, as a method of executing an application program in the WINDOWS operating system, the “Run . . . ” can be selected from a start menu of the WINDOWS operating system, and then the application program can be launched, for example, by inputting a statement in an input box: “winpopup.exe”. In case of using WINPOPUP, a user can directly input a message thereon and select a user (computer) or a work group that will receive the message, so that the converted power information message can be transmitted to a specified user through the application program WINPOPUP.

Then, at operation 25, the monitoring computer 20 displays the received power information, as shown, for example, in FIG. 4. Typically, the received power information is displayed according to the power information message. For example, the power information can be displayed on a messenger service window or a WINPOPUP window according to the message service window and WINPOPUP sending methods.

Thus, on the basis of the received power information currently displayed by the battery-powered computer 1, such as the allowable operating time, if a network disconnection is expected to happen when a job or a process by the battery-powered computer 1 has not been completed, a user can take a countermeasure before the disconnection happens. For example, on the basis of the received power information, if a disconnection is expected to happen when a job or a process by the battery-powered computer 1 has not been completed, the received allowable operating time can be compared with a remaining time for the job or the process to determine whether the job should continue to completion, normally aborted (interrupted), supply additional power to the battery-powered computer 1, etc. According to an aspect of the invention, in the case where the remaining job time is longer than the allowable operating time, a program may automatically perform the countermeasure. According to another aspect of the invention, a user performs the countermeasure.

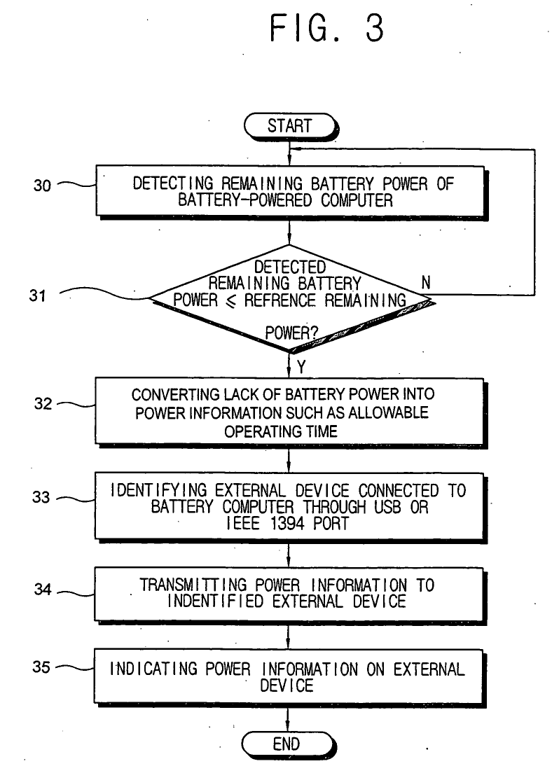

FIG. 3 is a flowchart of monitoring the remaining battery power of the computer using a battery through an external device in the process of controlling the computing device network system, according to an embodiment of the present invention. More particularly, a method of allowing the external device 30 to monitor the remaining battery power of the battery-powered computer 1 will be described hereinbelow with reference to FIG. 3.

Operation 30 to detect the remaining battery power of the battery-powered computer 1, operation 31 to compare the detected remaining battery power with the reference remaining power, and operation 32 to convert the detected remaining battery power into the power information, such as the allowable operating time, are identical with operations 20, 21 and 22 in FIG. 2, respectively. After operation 32, when the power information to be indicated by the external device 30 is determined, at operation 33, the battery-powered computer 1 identifies the external device 30 connected to the battery-powered computer 1 through an interface, such as the USB port, the IEEE 1394 port, etc. According to an aspect of the invention, the external device 30 connected to the interface is identified by reading data stored in a system registry or a GUID (Global Unique Identifier) in the case of the WINDOWS operating system, or by reading data previously set up in a device driver providing an interface with the application program. In this embodiment, operation 33 is performed after operation 32, but the present invention is not limited thereto, and operation 32 and 33 can be performed reversibly or simultaneously, because they can be independently performed.

Thereafter, at operation 34, the computer 1 via the identified port for the identified external device 30 sends the power information. In particular, at operation 34, a power information control signal corresponding to the power information is output to the corresponding identified port for the identified external device on the basis of the read external device port data. Then, at operation 35, the external device 30 indicates (displays or presents) the power information based on the received control signal. According to an aspect of the invention, as a method of indicating the received power information, a user of the external device 30 is also warned of the lack of the battery power by an LED (Light Emitting Diode), a speaker, an alarm driven by software operation, by a graphical user interface (FIG. 4), etc., provided in the external device 30. Further, the power information control signal received by the external apparatus 30 can be variously set up according to the power information. Thus, for example, a flickering period of the LED, and a beep of the speaker can vary according to the various power information control signals. Further, in the case that a visual equipment, such as the digital camera and the digital camcorder, is employed as the external device 30, the power information control signal can be used to display the power information on a display part of the visual equipment.

Thus, according to the present invention, on the basis of the received power information, such as the allowable operating time, currently displayed by the monitoring computer 20, 30, if a disconnection is expected to happen when a work/job or an operation related to the battery-powered computer 1 is not completed, a user or the monitoring computer 20, 30 (as the case may be) can take a countermeasure before the disconnection happens. For example, on the basis of the received power information by the monitoring computer 20, 30, if a disconnection is expected to happen when a job or an operation is not completed, the allowable operating time can be compared with a remaining time for the job or operation to determine an appropriate counter measure. According to an aspect of the invention, in the case where the remaining time is longer than the allowable operating time, a program may automatically perform the countermeasure. According to another aspect of the invention, a user may perform the countermeasure.

The present invention provides a method of controlling (i.e., monitoring) connection to a network system, in which a computer in processing network communication with a monitoring computer notifies the monitoring computer of a predictable network disconnection event, thereby allowing the monitoring computer to prepare for a sudden disconnection because of the predictable network disconnection event. More particularly, for example, a computer using a battery notifies remaining battery power to a monitoring computer connected and mutually working over a network with the battery operated computer, so that the monitoring computer can prepare against sudden disconnection events because of power issues with the battery operated computer.

Therefore, the present invention provides monitoring a connection with a network by informing a monitoring computer working with a target or a host computing device on the network of a predictable network disconnection event, thereby allowing countermeasures by the monitoring computer to the predictable network disconnection event. A monitoring computer is any computing device, such as a client computing device in case of a client-server network environment, a mobile computing device/computer, a camcorder, etc., working over a network with a host computing device, such as another computer, a server computing device in the case of the client-server network environment, a mobile computing device/computer etc. A predictable network disconnection between the monitoring computer and the host computer can be any event on the host computer that can cause a network disconnection with the host computer and can be reasonably predicted based upon monitoring of a processing environment (i.e., processing conditions) of the host computer, such as a power failure, because of low battery or other power issues, a processing failure due to load, network communication failure, etc. For example, when employing a battery as a power source to the host computer, the host computer detects a remaining battery power of the battery and transmits power related information (analyzed or annotated power information) based on the detected remaining battery power to the monitoring computer. The monitoring computer indicates the received power information, thereby allowing the monitoring computer to prepare against such sudden predictable network disconnection with the host computer.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A method of controlling a network system comprising a monitoring computer working with a computer employing a battery as a power source over the network, the method comprising:
detecting remaining battery power of the battery;
transmitting power information based on the remaining battery power to the monitoring computer; and
indicating the power information in the monitoring computer.

2. The method according to claim 1, further comprising converting the remaining battery power into an allowable operating time as the power information.

3. The method according to claim 1, further comprising comparing the remaining battery power with a reference remaining battery power to determine a lack of battery power as the power information.

4. The method according to claim 1, wherein the power information is transmitted to an identified IP address after identifying an IP address of the monitoring computer.

5. The method according to claim 4, wherein the power information is transmitted through a messenger service provided in operation systems of both the computer using the battery and the monitoring computer.

6. The method according to claim 4, wherein the power information is transmitted through an application program executed in both the computer using the battery and the monitoring computer.

7. The method according to claim 1, wherein the power information is transmitted to an external device as the monitoring computer connected to the computer using the battery through a USB port or an IEEE 1394 port interface between the external device and the computer using the battery.

8. A method, comprising:
informing a client computing device in a network communication with a host computer of a predictable network disconnection event based upon a processing environment of the host computer, thereby allowing the client computing device to countermeasure the predictable network disconnection event.

9. The method of claim 8, wherein a battery supplies power to the host computer, and the method further comprises:
detecting remaining battery power of the battery; and
determining power related information according to the detected remaining battery power; and
transmitting to the client computing device the determined power information as the predictable network disconnection event.

10. The method of claim 8, wherein the predictable network disconnection event comprises a countermeasure.

11. The method of claim 8, further comprising automatically performing a countermeasure by a program of the client computing device in the network communication with the host computer.

12. The method of claim 8, further comprising warning a user of the predictable network disconnection event by the client computing device via one or more of a light emitting diode, a speaker, and a graphical user interface.

13. The method of claim 8, wherein the network is Internet, and the method further comprises:
identifying an Internet Protocol (IP) address of the client computing device; and
the informing comprises transmitting the predictable network disconnection event to the client computing device via the Internet using the identified IP address of the client computing device.

14. The method of claim 8, wherein the network is a universal serial bus (USB) or an IEEE 1394 network interface, and the method further comprises:
reading identification data of the client computer in a registry of the host computer; and
the informing comprises transmitting the predictable network disconnection event to the client computing device via the USB or the IEEE 1394 network interface using the read identification data of the client computing device.

15. The method of claim 13, wherein the informing comprises inputting the identified IP address and the predictable network disconnection event in a messenger service of the host computer to transmit the predictable network disconnection event via the Internet to a messenger service of the client computing device.

16. An apparatus, comprising:
a client computing device; and
a host computer in a network communication with the client computing device and comprising a programmed computer processor controlling the host computer according to a process comprising:
determining a predictable network disconnection event based upon processing environment of the host computer, and
informing the client computing device of the predictable network disconnection event, thereby allowing the client computing device to countermeasure the predictable network disconnection event.

17. The apparatus of claim 16, wherein the client computing device comprises one or more of a light emitting diode, a speaker, and display device, and a programmed computer processor controlling the client computing device to warn a user of the predictable network disconnection via one or more of the light emitting diode, the speaker, and a graphical user interface on the display device.

18. A machine readable data storage storing at least one program controlling a host computing according to a process comprising:
informing a client computing device in a network communication with the host computer of a predictable network disconnection event based upon a processing environment of the host computer, thereby allowing the client computing device to countermeasure the predictable network disconnection event.
